(19) United States
(12) Patent Application Publication
(10) Pub. No.: US 2025/0265110 A1
(43) Pub. Date: Aug. 21, 2025

(54) STORAGE DEVICE, METHOD OF OPERATING THE SAME, AND COMPUTING SYSTEM INCLUDING THE STORAGE DEVICE

(71) Applicant: SK hynix Inc., Gyeonggi-do (KR)

(72) Inventors: Ku Ik KWON, Gyeonggi-do (KR); In Sung SONG, Gyeonggi-do (KR); Jin Won JANG, Gyeonggi-do (KR); Byoung Min JIN, Gyeonggi-do (KR)

(21) Appl. No.: 18/808,081

(22) Filed: Aug. 19, 2024

(30) Foreign Application Priority Data
Feb. 16, 2024 (KR) 10-2024-0022727

(51) Int. Cl. G06F 9/48; G06F 11/34

(52) U.S. Cl. CPC G06F 9/4831; G06F 11/3495

(57) ABSTRACT

A method of operating a storage device may include externally receiving a first target command of an administration command type, receiving a first data input/output command following the first target command, monitoring first data processing performance corresponding to the first data input/output command, and setting, based on a result of monitoring the first data processing performance, a priority related to response latency for outputting a processed result corresponding to a command of the administration command type.

### CROSS-REFERENCE TO RELATED APPLICATION

The present application claims priority under 35 U.S.C. § 119(a) to Korean patent application number 10-2024-0022727 filed on Feb. 16, 2024, the entire disclosure of which is incorporated by reference herein.

### BACKGROUND

### 1. Field of Invention

Various embodiments of the present disclosure generally relate to an electronic device, and more particularly to a storage device and a computing system including the same.

### 2. Description of Related Art

A storage device is a device which stores data under the control of a host device, such as a computer or a smartphone. The storage device may include a memory device in which data is stored and a memory controller which controls the memory device. Memory devices are classified into volatile memory devices and nonvolatile memory devices.

### SUMMARY

Various embodiments of the present disclosure are directed to a memory controller and a method of operating the memory controller, which improve data processing performance corresponding to data input/output commands received after an administration command from a host by adjusting response latency of the administration command received from the host.

An embodiment of the present disclosure may provide for a method of operating a storage device. The method may include externally receiving a first target command of an administration command type, externally receiving a first data input/output command following the first target command, monitoring first data processing performance corresponding to the first data input/output command, and setting, based on a result of monitoring the first data processing performance, a priority related to response latency for outputting a processed result corresponding to a command of the administration command type.

An embodiment of the present disclosure may provide a storage device. The storage device may include a memory device and a controller. The memory device may be configured to store data. The controller may be configured to externally receive a first target command of an administration command type, externally receive a first data input/output command following the first target command, monitor first data processing performance corresponding to the first data input/output command, and set, based on a result of monitoring the first data processing performance, a priority related to response latency for outputting a processed result corresponding to a command of the administration command type.

An embodiment of the present disclosure may provide for a method of operating a computing system including a storage device and a host. The method may include transmitting a first target command of an administration command type and a data input/output command from the host to the storage device, transmitting a response to the first target command from the storage device to the host based on preset response latency of the first target command, monitoring data processing performance corresponding to the data input/output command, and adjusting a response latency of a command of the administration command type based on a result of monitoring the data processing performance.

### BRIEF DESCRIPTION OF THE DRAWINGS

FIG. 1 is a diagram illustrating a configuration of a storage device according to an embodiment of the present disclosure.

FIG. 2 is a diagram for describing data input/output commands according to an embodiment of the present disclosure.

FIG. 3 is a diagram for describing data processing performance according to an embodiment of the present disclosure.

FIG. 4 is a diagram for describing improvement of data processing performance based on response latency adjustment of an administration command, according to an embodiment of the present disclosure.

FIG. 5 is a diagram for describing priority values of administration commands, according to an embodiment of the present disclosure.

FIG. 6 is a flowchart for describing an operation of a storage device according to an embodiment of the present disclosure.

FIG. 7 is a flowchart for describing an operation of a storage device according to an embodiment of the present disclosure.

FIG. 8 is a flowchart for describing an operation of a computing system according to an embodiment of the present disclosure.

FIG. 9 is a diagram illustrating a configuration of a memory controller according to an embodiment of the present disclosure.

### DETAILED DESCRIPTION

Specific structural or functional descriptions in the embodiments of the present disclosure introduced in this specification are provided as examples to describe embodiments according to the concept of the present disclosure. The embodiments according to the concept of the present disclosure may be practiced in various forms and should not be construed as being limited to the embodiments described in the specification.

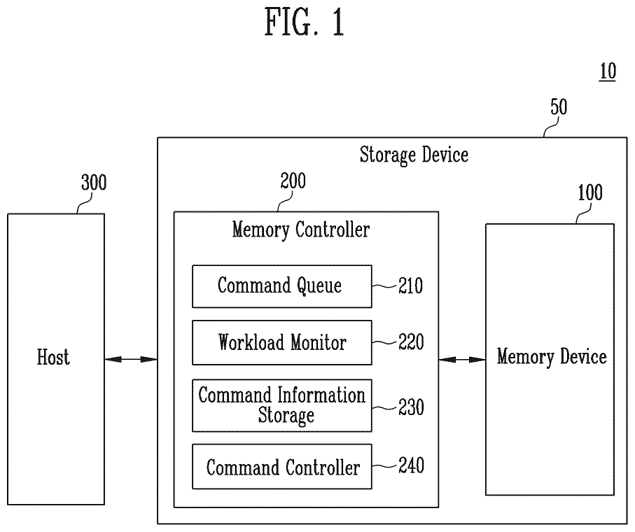

FIG. 1 is a diagram illustrating a configuration of a storage device 50 according to an embodiment of the present disclosure.

Referring to FIG. 1, a computing system 10 may include the storage device 50 and a host 300. The storage device 50 may include a memory device 100 and a memory controller 200 which controls the operation of the memory device 100. The memory controller 200 may be referred to as a controller. The storage device 50 may be a device which stores data under the control of the host 300, such as a mobile phone, a smartphone, an MP3 player, a laptop computer, a desktop computer, a game console, a television (TV), a tablet PC, an in-vehicle infotainment system, or a server.

The storage device 50 may be manufactured as any of various types of storage devices depending on a host interface that is a scheme for communication with the host 300. For example, the storage device 50 may be implemented as any of various types of storage devices, such as a universal serial bus (USB) storage device, a universal flash storage (UFS) device, a peripheral component interconnection (PCI) card-type storage device, a PCI express (PCI-E) card-type storage device, and a compact flash (CF) card.

The memory device 100 may store data. The memory device 100 may operate under the control of the memory controller 200. The memory device 100 may include a memory cell array including a plurality of memory cells which store data.

The memory cell array may include a plurality of memory blocks. Each memory block may include a plurality of memory cells. One memory block may include a plurality of pages. In an embodiment, each page may be the unit by which data is stored in the memory device 100 or by which data stored in the memory device 100 is read. A memory block may be the unit by which data is erased.

The memory device 100 may receive a command and an address from the memory controller 200, and may access the area of the memory cell array corresponding to the received address. That is, the memory device 100 may perform an operation indicated by the command on the area of the memory cell array selected by the address. For example, the memory device 100 may perform a write operation (program operation), a read operation, and an erase operation. During a program operation, the memory device 100 may store data by programming the data to the area of the memory cell array selected by the address. During a read operation, the memory device 100 may read data stored in the area of the memory cell array selected by the address from the area. During an erase operation, the memory device 100 may erase data stored in the area of the memory cell array selected by the address.

The memory controller 200 controls the overall operation of the storage device 50.

When power is applied to the storage device 50, the memory controller 200 may run firmware (FW). When the memory device 100 is a flash memory device, the memory controller 200 may run firmware such as a flash translation layer (FTL) for controlling communication between the host 300 and the memory device 100.

In an embodiment, the memory controller 200 may receive data and a logical block address (LBA) from the host 300, and may translate the logical block address (LBA) into a physical block address (PBA) indicating the address of memory blocks which are included in the memory device 100 and in which data is to be stored.

The memory controller 200 may control the memory device 100 so that a write operation, a read operation or an erase operation is performed in response to a request received from the host 300. During a program operation, the memory controller 200 may provide a write command, a physical block address, and data to the memory device 100. During a read operation, the memory controller 200 may provide a read command and a physical block address to the memory device 100. During an erase operation, the memory controller 200 may provide an erase command and a physical block address to the memory device 100.

In an embodiment, the memory controller 200 may independently generate a command, an address, and data regardless of whether a request from the host 300 is received, and may transmit them to the memory device 100. For example, the memory controller 200 may provide program, read or erase commands, addresses, and data required for performing background operations, such as wear leveling or garbage collection, to the memory device 100.

The host 300 may communicate with the storage device 50 using at least one of various communication standards or interfaces such as universal serial bus (USB), serial AT attachment (SATA), serial attached SCSI (SAS), high speed interchip (HSIC), small computer system interface (SCSI), peripheral component interconnection (PCI), PCI express (PCIe), nonvolatile memory express (NVMe), universal flash storage (UFS), secure digital (SD), and dual in-line memory module (DIMM) interfaces.

In an embodiment, the memory controller 200 may include a command queue 210, a workload monitor 220, a command information storage 230, and a command controller 240.

The command queue 210 may sequentially store a plurality of commands received from the host 300. The plurality of commands may include a data input/output command and an administration command. The data input/output command may be a command for writing or reading data to or from the memory device 100 in response to a request received from the host 300. The administration command may refer to all commands received from the host 300, except the data input/output command. In an embodiment, the administration command may include a command for checking the status of the memory device 100.

The workload monitor 220 may measure data processing performance corresponding to the data input/output command among a plurality of commands. For example, the workload monitor 220 may measure data processing performance based on the amount of data communicated with the host 300 during a preset time. Here, the data may be data corresponding to the data input/output command received from the host 300 during the preset time. In an embodiment, the workload monitor 220 may measure data processing performance based on the number of instructions processed in response to the command of the host 300 during the preset time.

The workload monitor 220 may remeasure data processing performance when the priority value of the administration command changes. For example, when the administration command is re-input to the command queue 210 after the priority value of the administration command has changed, the workload monitor 220 may remeasure data processing performance based on a data input/output command that is input to the command queue 210 after the re-input administration command.

The command information storage 230 may store the priority value indicating the priority of the administration command. The initial priority value of the administration command may be set to a default value.

The command controller 240 may compare the data processing performance with the maximum value of the data processing performance. The maximum value of the data processing performance may be the maximum value of performance for processing data corresponding to the data input/output command, and may be determined based on the maximum amount of data that corresponds to the data input/output command and that can be communicated by the storage device 50 with the host 300 during the preset time. The command controller 240 may adjust response latency of the administration command input to the command queue 210 before the data input/output command, based on the result of the comparison. The command controller 240 may decrease the response latency of the administration command when the data processing performance is lower than the maximum value of the data processing performance. The command controller 240 may set the priority of the administration command to adjust the response latency of the administration command.

The command controller 240 may set the initial priority value of the administration command to a default value so as to set the priority of the administration command, and may change the priority value.

For example, the command controller 240 may change the priority value of the administration command when the data processing performance is lower than the maximum value of the data processing performance. The command controller 240 may sequentially increase or decrease the priority value of the administration command until the data processing performance reaches the maximum value of the data processing performance. The command controller 240 may sequentially increase or decrease the priority value of the administration command until the priority value of the administration command reaches a threshold value. The command controller 240 may set the priority value of the administration command, stored in the command information storage 230, to a value before being changed when the data processing performance is not improved even if the priority value of the administration command has changed. The command controller 240 may set the priority value of the administration command, stored in the command information storage 230, to a changed value when the data processing performance is improved through the change of the priority value of the administration command.

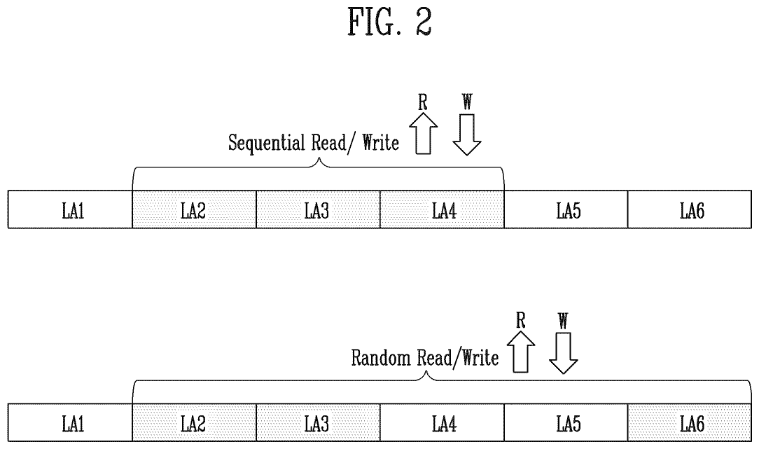

FIG. 2 is a diagram for describing data input/output commands according to an embodiment of the present disclosure.

Referring to FIG. 2, the data input/output commands may include a sequential read command, a sequential write command, a random read command, and a random write command.

The sequential read command may be a command for reading data stored in consecutive logical areas LA2 to LA4. The sequential write command may be a command for programming data to the consecutive logical areas LA2 to LA4. The random read command may be a command for reading data from one or more non-consecutive logical areas LA2, LA3, and LA6. The random write command may be a command for programming data to one or more non-consecutive logical areas LA2, LA3, and LA6.

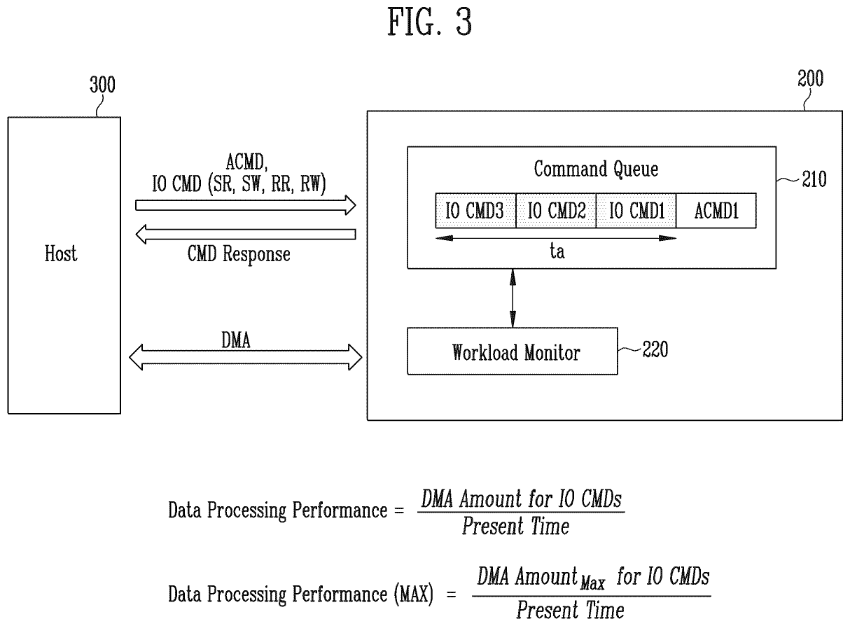

FIG. 3 is a diagram for describing data processing performance according to an embodiment of the present disclosure.

Referring to FIG. 3, the memory controller 200 may receive an administration command ACMD and data input/output commands IO CMD from the host 300. The memory controller 200 may provide (i.e., output) a response CMD Response to each command, received from the host 300, to the host 300. The memory controller 200 may receive write data from the host 300 or provide read data to the host 300 in response to the input/output commands IO CMD.

The command queue 210 may sequentially store a plurality of commands received from the host 300. The workload monitor 220 may determine workload based on data input/output commands IO CMD received from the host 300 during a preset time. The workload monitor 220 may measure data processing performance based on the amount of data exchanged with the host 300 during the preset time. The maximum value of the data processing performance may be determined based on the maximum amount of data that corresponds to the data input/output commands IO CMD and that can be exchanged with the host 300 during the preset time.

In FIG. 3, the command queue 210 may store a first administration command ACMD1 and first to third data input/output commands IO CMD1 to IO CMD3, which are sequentially received from the host 300. The command queue 210 may sequentially receive the first to third data input/output commands IO CMD1 to IO CMD3 during a time ta.

The workload monitor 220 may measure, as data processing performance, the amount of data exchanged with the host 300 in response to the first to third data input/output commands IO CMD1 to IO CMD3 during the time ta. The workload monitor 220 may determine the amount of data by counting the number of direct memory access (DMA) requests received from the host 300 during the time ta.

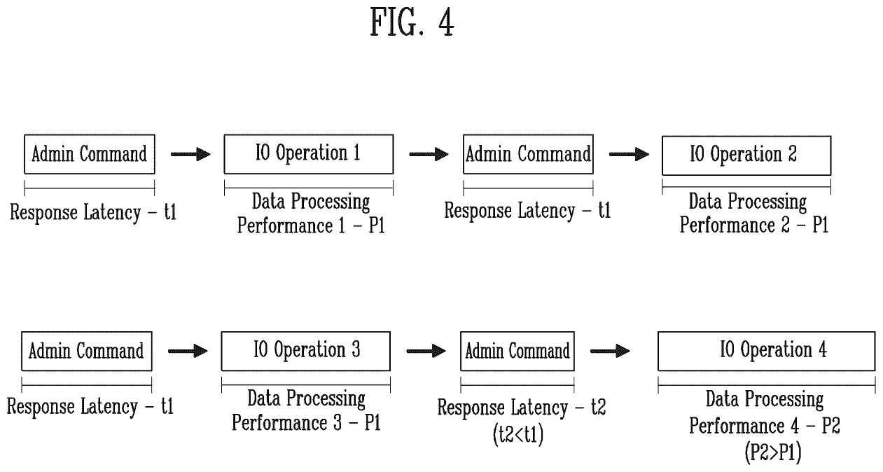

FIG. 4 is a diagram for describing improvement of data processing performance based on response latency adjustment of an administration command, according to an embodiment of the present disclosure.

Referring to FIG. 4, when response latency of an administration command is t1 in (a), first data processing performance, corresponding to a first input/output operation performed after a response to the administration command is made, may be P1. When response latency of an administration command that is re-input after the first input/output operation is performed is t1, second data processing performance, corresponding to a second input/output operation performed after a response to the re-input administration command is made, may be P1.

When response latency of an administration command is t1 in (b), third data processing performance, corresponding to a third input/output operation performed after a response to the administration command is made, may be P1. When response latency of an administration command that is re-input after the third input/output operation is performed is t2 (where t2<t1), fourth data processing performance, corresponding to a fourth input/output operation performed after a response to the re-input administration command is made, may be P2 (where P2>P1).

Comparing (a) with (b), it can be seen that data processing performance, corresponding to the input/output operation performed in response to the corresponding data input/output command, is influenced by the response latency of the administration command that is input before the corresponding data input/output command. In FIG. 4, when the response latency of the administration command decreases from t1 to t2, data processing performance may be improved from P1 to P2.

That is, according to an embodiment of the present disclosure, data processing performance corresponding to a data input/output command is influenced by the response latency of an administration command before the data input/output command, and thus the priority of the administration command may be set to adjust the response latency of the administration command. In an embodiment, in order to decrease the response latency of the administration command, a priority value indicating the priority of the administration command may be changed.

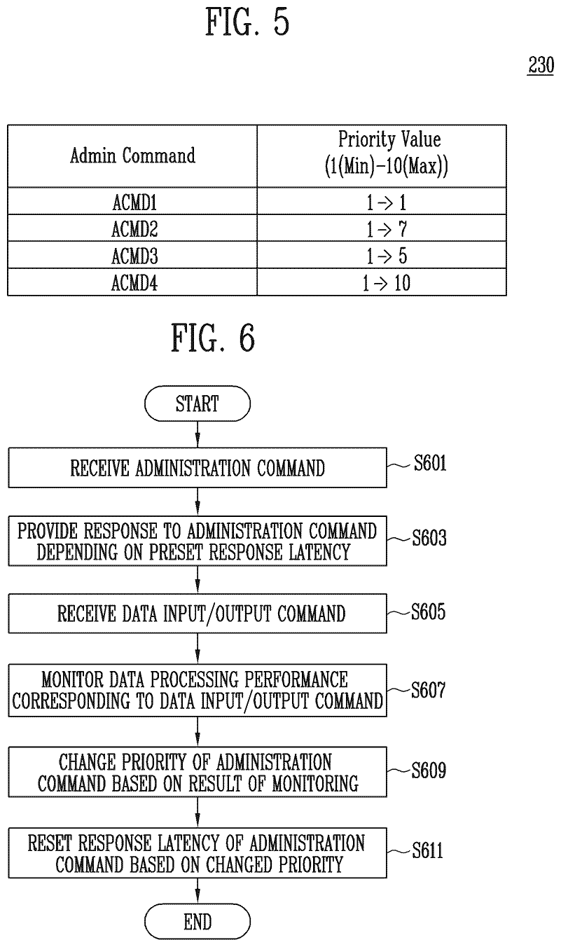

FIG. 5 is a diagram for describing priority values of administration commands, according to an embodiment of the present disclosure.

Referring to FIG. 5, the command information storage 230 may store the priority values of administration commands. The administration commands may refer to all commands received from a host, except data input/output commands. In an embodiment, the administration commands may include a command for checking the status of the memory device 100.

In FIG. 5, the minimum value of the priority values may be 1, and the maximum value thereof may be 10. However, the range of the priority values is not limited to the present embodiment. As a priority value is lower, priority may be lower, whereas as the priority value is higher, priority may be higher.

The initial priority value of first to fourth administration commands ACMD1 to ACMD4 may be set to a default value. The default value may be 1, which is the minimum value of the priority values. The default value may be set in various manners. The priority values of the first to fourth administration commands ACMD1 to ACMD4 may be set to 1, 7, 5, and 10, respectively, due to the change of the priority values, described with reference to FIG. 4. In FIG. 5, a threshold value may be 10, which the maximum value of the priority values.

Because the priority value of the first administration command ACMD1 is set to 1, which is the same as a previous value, it can be seen that data processing performance is not improved even if the priority value changes.

Because the priority values of the second to fourth administration commands ACMD2 to ACMD4 have changed from the previous value, it can be seen that data processing performance is improved due to an increase in the priority of the administration command (or a decrease in response latency).

However, it can be seen that data processing performance is continuously improved until the priority value of the second administration command ACMD2 changes from 1 to 7, but data processing performance is not improved when the priority value thereof has changed to 8. Similarly, it can be seen that data processing performance is continuously improved until the priority value of the third administration command ACMD3 changes from 1 to 5, but data processing performance is not improved when the priority value thereof has changed to 6.

It can be seen that data processing performance is continuously improved due to an increase in the priority of the fourth administration command ACMD4 (or a decrease in response latency) until the priority value of the fourth administration command ACMD4 changes from 1 to 10, which is the threshold value.

FIG. 6 is a flowchart for describing an operation of a storage device according to an embodiment of the present disclosure.

Referring to FIG. 6, at operation S601, the storage device may receive an administration command from a host. The administration command may include a command for requesting status information of the storage device.

At operation S603, the storage device may provide (i.e., output) a response to the administration command to the host based on the preset response latency of the administration command.

At operation S605, the storage device may receive a data input/output command from the host.

At operation S607, the storage device may monitor data processing performance corresponding to the data input/output command. A method of monitoring the data processing performance is the same as that described above with reference to FIG. 3.

At operation S609, the storage device may change the priority of the administration command based on the result of monitoring.

At operation S611, the storage device may reset the response latency of the administration command based on the changed priority. In an embodiment, when an administration command is received again from the host, the storage device may provide a response to the administration command to the host based on the reset response latency.

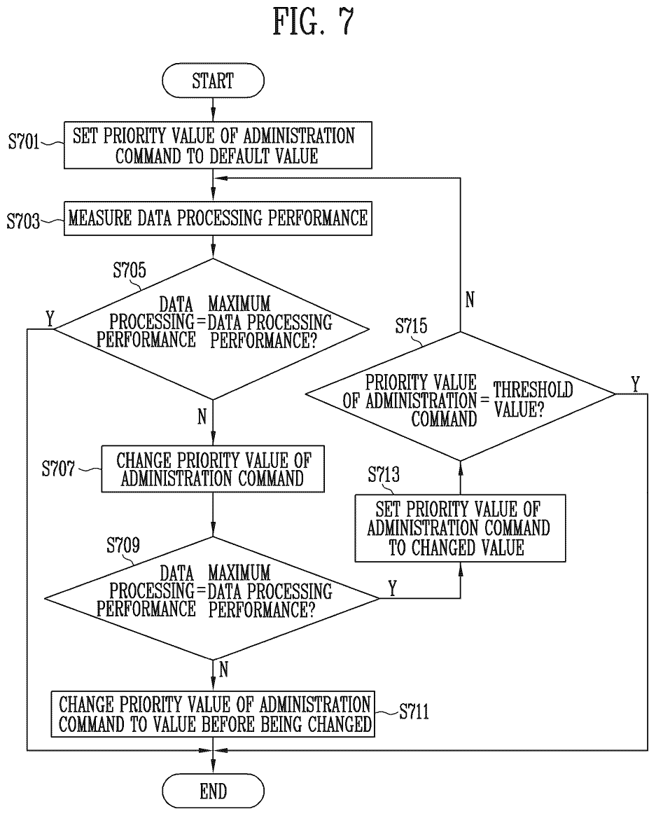

FIG. 7 is a flowchart for describing an operation of a storage device according to an embodiment of the present disclosure.

Referring to FIG. 7, at operation S701, the storage device may set the priority value of an administration command to a default value. For example, a memory controller may store the priority value of the administration command, and may set the initial priority value of the administration command to the default value. The administration command may refer to all commands received from a host, except commands for data input/output.

At operation S703, the storage device may measure data processing performance. For example, a memory controller may measure data processing performance based on the amount of data exchanged with the host during a preset time in response to a data input/output command.

At operation S705, the storage device may determine whether the data processing performance is equal to the maximum value of the data processing performance. When it is determined that the data processing performance is equal to the maximum value of the data processing performance (i.e., ‘Y’ in the operation S705), the storage device terminates the operation. When it is determined that the data processing performance is lower than the maximum value of the data processing performance (i.e., ‘N’ in the operation S705), the storage device proceeds to operation S707. The maximum value of the data processing performance may be determined based on the maximum amount of data that can be exchanged with the host during a preset time in response to the data input/output command.

At the operation S707, the storage device may change the priority value of the administration command to increase the priority of the administration command. For example, the memory controller may sequentially increase or decrease the priority value of the administration command. In an embodiment, the memory controller may sequentially increase the priority value of the administration command to increase the priority of the administration command.

At operation S709, the storage device may determine whether the data processing performance has been improved through the change of the priority value of the administration command. When it is determined that the data processing performance has been improved (i.e., ‘Y’ in the operation S709), the storage device proceeds to operation S713. When it is determined that the data processing performance has not been improved (i.e., ‘N’ in the operation S709), the storage device proceeds to operation S711.

For example, when an administration command is re-input after the priority value of the administration command has changed, the memory controller may process the administration command based on the changed priority value. For example, a response to the administration command may be provided to the host based on response latency corresponding to the changed priority value. The memory controller may remeasure data processing performance corresponding to a data input/output command that is input after the re-input administration command. The memory controller may determine whether the data processing performance has been improved by comparing the remeasured data processing performance with the previous data processing performance.

At the operation S711, the storage device may set the priority value of the administration command to a value before being changed.

The value before being changed may be the priority value of the administration command before the priority changes at the operation S707.

At the operation S713, the storage device may set the priority value of the administration command to the changed value. The changed value may be the priority value of the administration command after the priority has changed at the operation S707.

Referring to the operations S711 and S713, the priority value of the administration command may be updated to the changed value only when the data processing performance is improved.

At operation S715, the storage device may determine whether the priority value of the administration command is equal to a threshold value. When it is determined that the priority value of the administration command is equal to the threshold value (i.e., ‘Y’ in the operation S715), the storage device may terminate the operation. When it is determined that the priority value is different from the threshold value (i.e., ‘N’ in the operation S715), the storage device returns to the operation 703.

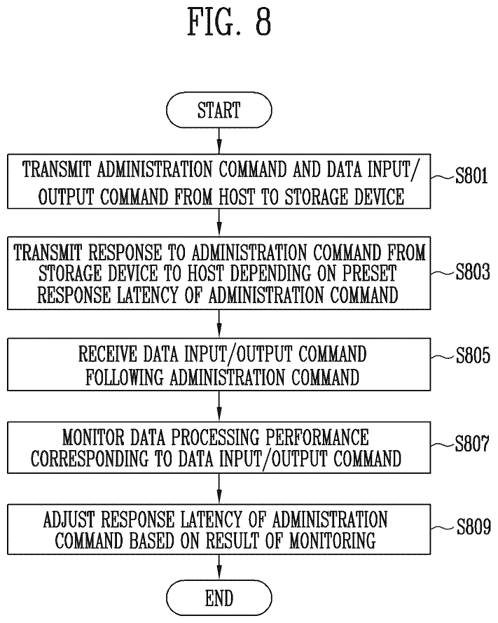

FIG. 8 is a flowchart for describing an operation of a computing system according to an embodiment of the present disclosure.

Referring to FIG. 8, at operation S801, the computing system may transmit an administration command and a data input/output command from a host to a storage device.

At operation S803, the computing system may transmit a response to the administration command from the storage device to the host based on the preset response latency of the administration command.

At operation S805, the computing system may receive a data input/output command following the administration command.

At operation S807, the computing system may monitor data processing performance corresponding to the data input/output command.

At operation S809, the computing system may adjust the response latency of the administration command based on the result of monitoring.

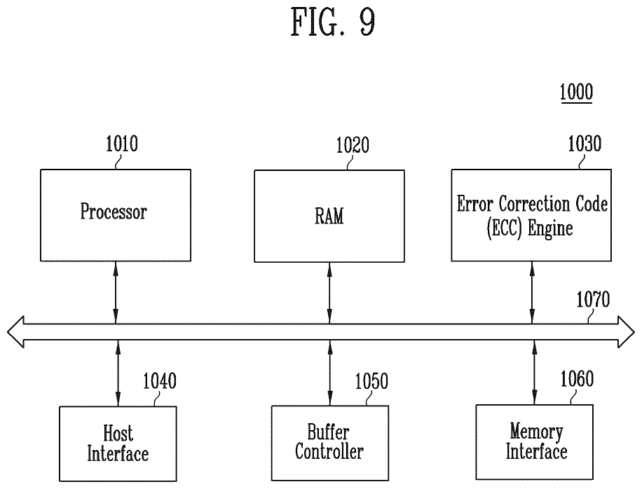

FIG. 9 is a diagram illustrating a configuration of a memory controller 1000 according to an embodiment of the present disclosure.

Referring to FIG. 9, the memory controller 1000 may be coupled to a host and a memory device. The memory controller 1000 may access the memory device in response to a request received from the host.

The memory controller 1000 illustrated in FIG. 9 may correspond to the memory controller 200 illustrated in FIG. 1.

The memory controller 1000 may control a read or write operation of the memory device. The memory controller 1000 may provide an interface between the memory device and the host. The memory controller 1000 may run firmware for controlling the memory device.

The memory controller 1000 may include a processor 1010, a RAM 1020, an error correction code (ECC) engine 1030, a host interface 1040, a buffer controller 1050, a memory interface 1060, and a bus 1070.

The bus 1070 may provide a channel between components of the memory controller 1000.

The processor 1010 may control the overall operation of the memory controller 1000 and perform a logical operation. The processor 1010 may communicate with a host (i.e., an external device) through the host interface 1040 and communicate with the memory device through the memory interface 1060. Further, the processor 1010 may communicate with the RAM 1020 through the buffer controller 1050. The processor 1010 may control the operation of the storage device by using the RAM 1020 as a working memory, a cache memory or a buffer memory.

The RAM 1020 may be used as the working memory, the cache memory, or the buffer memory of the processor 1010. The RAM 1020 may store codes and commands to be executed by the processor 1010. The RAM 1020 may store data that is processed by the processor 1010. The RAM 1020 may include a static RAM (SRAM) or a dynamic RAM (DRAM).

The error correction code (ECC) engine 1030 may perform error correction. The ECC engine 1030 may perform ECC encoding based on data to be written to the memory device through the memory interface 1060. The ECC-encoded data may be transferred to the memory device through the memory interface 1060. The ECC engine 1030 may perform ECC decoding on data received from the memory device through the memory interface 1060. In an example, the ECC engine 1030 may be included as the component of the memory interface 1060 in the memory interface 1060.

The host interface 1040 may communicate with the host under the control of the processor 1010. The host interface 1040 may perform communication using at least one of various communication standards or interfaces such as universal serial bus (USB), serial AT attachment (SATA), serial attached SCSI (SAS), small computer system interface (SCSI), peripheral component interconnection (PCI), PCI express (PCIe), nonvolatile memory express (NVMe), and universal flash storage (UFS).

The buffer controller 1050 may control the RAM 1020 under the control of the processor 1010. The memory interface 1060 may transmit/receive commands, addresses, and data to/from the memory device through channels under the control of the processor 1010.

In an example, the processor 1010 may control the operation of the memory controller 1000 using codes. The processor 1010 may load codes from a nonvolatile memory device (e.g., read only memory: ROM) provided in the memory controller 1000. In an example, the processor 1010 may load codes from the memory device through the memory interface 1060.

In an example, the bus 1070 of the memory controller 1000 may be divided into a control bus and a data bus. The data bus may transmit data in the memory controller 1000, and the control bus may transmit control information, such as commands or addresses, in the memory controller 1000. The data bus and the control bus may be separated from each other, and may neither interfere with each other nor influence each other. The data bus may be coupled to the host interface 1040, the buffer controller 1050, the ECC engine 1030, and the memory interface 1060. The control bus may be coupled to the host interface 1040, the processor 1010, the buffer controller 1050, the RAM 1020, and the memory interface 1060.

According to embodiments of the present disclosure, there are provided a storage device, and a method of operating the same and a computing system including the storage device, which improve data processing performance corresponding to data input/output commands received after an administration command from a host by adjusting response latency of the administration command received from the host.

Various embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims. Furthermore, the embodiments may be combined to form additional embodiments.

What is claimed is:

1. A method of operating a storage device, the method comprising:
externally receiving a first target command of an administration command type;
externally receiving a first data input/output command following the first target command;
monitoring first data processing performance corresponding to the first data input/output command; and
setting, based on a result of monitoring the first data processing performance, a priority related to response latency for outputting a processed result corresponding to a command of the administration command type.

2. The method according to claim 1, further comprising adjusting the response latency corresponding to the command of the administration command type based on the set priority.

3. The method according to claim 2, further comprising:
externally receiving a second target command of the administration command type; and
outputting a processed result corresponding to the second target command based on the adjusted response latency.

4. The method according to claim 3, further comprising:
externally receiving a second data input/output command after the second target command is received;
monitoring second data processing performance corresponding to the second data input/output command; and
setting the priority related to the response latency corresponding to the first target command based on a result of monitoring the second data processing performance.

5. The method according to claim 1, further comprising setting the priority to a default value.

6. The method according to claim 1, wherein setting the priority comprises:
maintaining or changing the priority depending on a result of comparing the monitored first data processing performance with a maximum value of the first data processing performance.

7. The method according to claim 6, further comprising:
maintaining the priority in response to a determination that the monitored first data processing performance is equal to the maximum value of the first data processing performance; and
increasing the priority in response to a determination that the monitored first data processing performance is lower than the maximum value of the first data processing performance.

8. The method according to claim 7, further comprising sequentially increasing the priority until the monitored first data processing performance reaches the maximum value of the first data processing performance.

9. The method according to claim 7, further comprising sequentially increasing the priority until the set priority reaches a threshold value.

10. The method according to claim 7, further comprising: setting the set priority to a previous value in response to a determination that an additionally monitored first data processing performance, after setting the priority, is equal to the monitored first data processing performance.

11. A storage device comprising:
a memory device configured to store data; and
a controller configured to:
externally receive a first target command of an administration command type;
externally receive a first data input/output command following the first target command;
monitor first data processing performance corresponding to the first data input/output command; and
set, based on a result of monitoring the first data processing performance, a priority related to response latency for outputting a processed result corresponding to a command of the administration command type.

12. The storage device according to claim 11, wherein the controller comprises:
a command queue configured to store the first target command and the first data input/output command;
a workload monitor configured to monitor the first data processing performance; and
a command controller configured to adjust the response latency corresponding to the command of the administration command type based on the result of monitoring the first data processing performance.

13. The storage device according to claim 12, wherein the workload monitor is configured to measure the first data processing performance based on an amount of data that is received and output during a preset time and that corresponds to the first data input/output command.

14. The storage device according to claim 12, wherein the command controller is configured to set the priority related to the response latency based on a result of comparing the first data processing performance with a maximum value of the first data processing performance.

15. The storage device according to claim 14, wherein the command controller is configured to increase the priority when the first data processing performance is lower than the maximum value of the first data processing performance.

16. The storage device according to claim 15, wherein the command controller is configured to sequentially increase the priority until the first data processing performance reaches the maximum value of the first data processing performance or until the priority reaches a threshold value.

17. A method of operating a computing system including a storage device and a host, the method comprising:
transmitting a first target command of an administration command type and a data input/output command from the host to the storage device;
transmitting a response to the first target command from the storage device to the host based on preset response latency of the first target command;
monitoring data processing performance corresponding to the data input/output command; and
adjusting a response latency of a command of the administration command type based on a result of monitoring the data processing performance.

18. The method according to claim 17, further comprising:
transmitting a second target command of the administration command type from the host to the storage device; and
transmitting a response to the second target command from the storage device to the host based on the adjusted response latency.

19. The method according to claim 17, wherein monitoring the data processing performance comprises measuring the data processing performance based on an amount of data that corresponds to the data input/output command and that is transmitted/received between the host and the storage device during a preset time.

20. The method according to claim 17, wherein adjusting the response latency of the command of the administration command type comprises:
comparing the data processing performance with a maximum value of the data processing performance corresponding to the data input/output command;
setting a priority of the command of the administration command type based on a result of the comparison; and
setting the response latency based on the set priority.
